(19) United States
(12) Patent Application Publication
(10) Pub. No.: US 2009/0255879 A1
(43) Pub. Date: Oct. 15, 2009

(54) Chlorination apparatus and method for use

(76) Inventor: Thomas D. Payeur, Sanford, ME (US)

Correspondence Address: CANTOR COLBURN, LLP, 20 Church Street, 22nd Floor, Hartford, CT, 06103, US

(21) Appl. No.: 12/100,627

(22) Filed: Apr. 10, 2008

(51) Int. Cl. C02F 1/68

(52) U.S. Cl. 210/754; 210/764; 210/206

(57) ABSTRACT

An apparatus for treating a potable water source can the apparatus comprise a solid phase treatment material for treating a potable water source, a solid phase treatment material dispenser comprising a floatation device and a container configured to hold the solid phase treatment material, the container comprising a bottom surface and sidewalls extending from the bottom surface, wherein the bottom surface and/or sidewalls comprise apertures, and wherein the flotation device can comprise a plurality of fasteners attached thereto, and, optionally, a opening securement system comprising a tether in operative communication with the plurality of fasteners and an attachment point about the opening, wherein the tether is configured to permit travel of the floatation device within the water storage tank.

### BACKGROUND

Drinking water is water that is safe for human consumption, and is termed “potable water”. Water that is not potable potentially has pathogenic microorganisms and other contaminants that can cause health problems, both in the short and long term. Many governments and organizations such as the U.S. Environmental Protection Agency (EPA), the World Heath Organization (WHO), and National Sanitation Foundation, (NSF) continue to develop guidelines for what constitutes safe potable water. Not only do the guidelines and regulations apply to the water, they also apply to the systems, pumps, pipes, etc., that are used in the treatment of the water. Each step in the water supply network offers the opportunity for contaminants to enter the water, which is why regulations also apply to the treatment methods and every material that could possibly come in contact with the water.

Drinking water is supplied to consumers via a water supply network. A water supply network in a municipality usually consists of the source of the water, e.g., watershed area, river, lake, stream, underground water supply, etc, which is delivered, via pipes or aqueducts, to a treatment facility. At the treatment facility, the water is treated for contaminants, particulate matter, etc. The water is then distributed to water storage tanks.

The water storage tanks are usually 125 to 200 feet (ft) high, are capable of holding greater than 100,000 gallons of water (can hold up to and exceeding 1,000,000 gallons of water), and are typically placed at or above ground level, for ease of construction, maintenance, and operation. The network may comprise multiple water storage tanks in order to accommodate fluctuating consumer demands, as well as to provide passive pressurization capability in the event of a power interruption to the main pumping facility. Finally through a series of pipes, water mains, etc., the water is delivered from the water storage tanks to the consumer. These types of water supply networks are usually found in the more developed countries that have the proper infrastructure and resources to treat, store, deliver, and regulate the safety of the water to many consumers at one time.

Water is treated at the treatment facility by both filtering out particulate matter, and then disinfecting to kill any bacteria, viruses, algae, etc. For disinfecting, chlorine may be used to disinfect the water, as it is very effective at killing most bacteria and algae. Chlorine can be used in gaseous, liquid, or solid form. Chlorine, however, is a very dangerous chemical and its use can create multiple safety concerns. To avoid these safety risks, other disinfecting methods that do not use chlorine can be used, such as UV radiation and Ozone treatment.

Regardless of the treatment method at the facility, after the water is treated, most regulations stipulate that the water must contain a residual disinfectant, or, “residual chlorine content”, before going to the water storage tanks. The residual disinfectant is supplied in order to continue treating the water while it is stored in the storage tanks. Residual chlorine content in the tanks is also regulated. Due to the importance of continued treatment, the residual chlorine content in the tanks is continually monitored to ensure compliance.

In the water storage tanks, depending on daily and seasonal usage, the residual chlorine content in the water may be lower than required. For example, storing the water for longer than expected might lower the chlorine level. In another example, in the warmer months, or when the water level is lower than normal, the water is more susceptible to toxic algae outbreaks. Lower than required residual chlorine levels allow for the increase and growth of contaminants that affect the quality of the potable water.

When the residual chlorine levels are too low, additional disinfectant, or treatment material, e.g., chlorine must be added to the water storage tanks. Normally, adding the treatment material involves climbing to the top of the tank, accessing the water through an access port, and then adding the disinfectant into the tank. This can be a very dangerous operation, due to both the dangers of climbing to the top of the tank, as well as handling large amounts of chemical disinfectant. To further exacerbate the safety hazards, often the disinfectant used is liquid chlorine, which poses safety hazards for the operator who can potentially come in contact with the chlorine fumes or the liquid itself. Other problems involved with current techniques for adding a liquid disinfect involve inadequate mixing. The liquid tends not to thoroughly disperse in the water, because the tanks are very large and dispersion within the tank is not currently controlled. Also, this “shock” treatment method tends to cause the residual disinfectant level to spike very high, which tends to be unpleasant for the consumer.

An alternative treatment method is to employ granulated disinfectant, such as granulated chlorine, in the tanks. While the granulated disinfectant may not pose as many safety hazards as a liquid disinfectant, other problems ensue. For example, the granules tend to sink to the bottom of the tank, thus the treatment material ends up only treating the sludge that tends to be present in tank bottoms. Thus, the granules fail to deliver a steady, constant amount of disinfectant throughout the water tank at all times.

The need to add additional disinfectant in order to maintain residual chlorine levels can be quite frequent, i.e., a weekly basis or more. Frequent trips are commonplace especially in the warmer months, when the water tank's volume may fluctuate on a very frequent basis. Likewise, warmer temperatures increase the speed of algae and bacterial growth, resulting in the need for additional treatment material. Other unforeseen conditions can unexpectedly affect the water tanks such that additional treatment material is needed, such as distribution line breaks, storm run-off events, source water contamination events, or cross-contamination events. Current techniques make it difficult, time consuming, and potentially dangerous to maintain chlorine levels at a specified level over an extended period of time, regardless of the water fluctuation, environmental conditions, and other issues affecting water quality.

Even further, due to the unpleasant and dangerous nature of adding disinfectant to the water storage tanks, it is not uncommon for municipalities to incur the expense of hiring specially trained outside companies to perform the task of traversing the tanks. Performing this service as often as once or twice a week, depending upon weather conditions and other unforeseen conditions, can be quite a substantial cost burden the municipalities are forced to incur. Unfortunately, frequent trips to the top of the water storage tanks are presently the only option.

Aside from municipalities in industrialized nations such as the U.S., there is a serious need for readily providing safe drinking water internationally; specifically to less-developed and/or poorer countries. The health problems associated with poor water quality are well documented in such countries, as is the number of people that do not have access to safe drinking water. Unfortunately, many less-developed countries suffer from poor water quality and health problems associated therewith. Poor water quality can be primarily attributed to uncontrolled/unregulated industrial pollution and contaminants, coupled with a lack of water treatment facilities, resources, and infrastructure. A water treatment method which does not require large capital expenditures and infrastructure, is portable, and is able to treat a wide variety of water tank volumes and water conditions could be valuable in such nations.

### BRIEF SUMMARY

Disclosed herein are an apparatus and method to treat a water source.

In one embodiment, the apparatus for treating a potable water source comprises: a solid phase treatment material for treating the potable water source, a dispenser for the solid phase treatment material, and optionally an opening securement system. The dispenser comprises a container and a floatation device. The container is configured to hold the solid phase treatment material. The container comprises a bottom surface and sidewall extending from the bottom surface, wherein the bottom surface and/or the sidewall comprise apertures. The opening securement system can comprise a tether in operative communication with fasteners on the floatation device and an attachment point about the opening. The tether can be configured to permit travel of the floatation device within the water storage tank. The apertures, buoyancy of the flotation device, and/or travel of the flotation device can be configured to provide a controlled dissolution rate of the treatment material.

In another embodiment, an apparatus for treating a water source comprises: and a solid phase treatment material for treating the water source, a container configured to hold the solid phase treatment material. The container is removably attached to a flotation device and comprises a bottom surface and sidewall extending from the bottom surface, wherein the bottom surface and/or the sidewall comprise apertures. The apertures, buoyancy of the flotation device, and/or travel of the flotation device are configured to provide a controlled dissolution rate of the treatment material. The water source comprises greater than 100,000 gallons of water.

In one embodiment, the method to maintain residual chlorine levels in water comprises: inserting a solid phase chlorine material for treating a potable water source into a chlorine dispenser comprising a floatation device container configured to hold the solid phase chlorine material (the container has a bottom surface and/or sidewall comprising apertures), disposing the container and floatation device into the water storage tank, wherein the apertures are in fluid communication with the water; and dissolving the solid phase chlorine material at a rate sufficient to maintain a predetermined residual chlorine level in the water for at least about three weeks.

The above described and other features are exemplified by the following detailed description and appended claims.

### BRIEF DESCRIPTION OF THE DRAWINGS

Refer now to the figures, which are meant to be exemplary, not limiting, and wherein the like elements are numbered alike.

FIG. 1 is a cross-sectional view of an exemplary embodiment of the apparatus.

FIG. 2 is a cross-sectional view of an exemplary embodiment of the container of the apparatus.

FIG. 3 is another cross-sectional view of an exemplary embodiment of the apparatus showing the floatation device and the container.

### DETAILED DESCRIPTION

Disclosed herein is an apparatus configured to disinfect water in a water storage tank and a method of use for the disclosed apparatus. The apparatus and method allow for disinfectant, such as chlorine, to be delivered to the water at a constant rate that maintains the residual chlorine content in the water at a substantially constant level (e.g., at a level of about 0.8 parts per million by weight (ppm) to about 1.25 ppm). The apparatus and method also enable the residual chlorine content to remain constant over an extended period of time, for example, at least about three to four weeks. The apparatus is designed to be adaptable and adjustable to accommodate storage tanks of various size and volumes, as well as water treatment networks exposed to various operating conditions.

The chlorinator apparatus and method described herein can advantageously reduce the number of times needed to supply disinfectant treatment material to one or more potable water storage tanks. In this regard, the apparatus disclosed herein reduces the frequency of climbs to the top of said water tanks from as much as twice or more per week to once per month or less. Reducing the number of trips to the top of the water storage tanks can decrease the risk associated with climbing heights of 125 feet (ft) plus to both the climbing worker, as well as those on the ground should something fall from such tank heights. Moreover, the apparatus disclosed herein can disinfect the potable water without the need for liquid chlorine. Lighter weight and easier to handle disinfectant tablets are favorably employed with the apparatus, thereby further reducing the current safety concerns associated with the handling of liquid chlorine and the physical risks associated with getting multiple gallons of such liquid to the top of a storage tower.

To reiterate, the apparatus and method disclosed herein reduces the number of trips to add disinfectant to current water storage tanks, delivers disinfectant to the water at a constant and reliable rate, maintains residual chlorine content in the water over an extended period of time (e.g., maintained at 1 ppm±0.2 ppm (and even at 1 ppm±0.1 ppm) for a period of greater than or equal to 3 weeks at ambient temperatures of greater than or equal to 80° F. (27° C.) without water temperature controls), and reduces the safety risks involved with maintaining water quality by current techniques.

In one embodiment, the apparatus for treating a potable water source comprises: a solid phase treatment material for treating the potable water source, a dispenser for the solid phase treatment material, and optionally an opening securement system. The dispenser comprises a container and a floatation device. The container is configured to hold the solid phase treatment material. The container comprises a bottom surface and sidewall extending from the bottom surface, wherein the bottom surface and/or the sidewall comprise apertures. The opening securement system can comprise a tether in operative communication with fasteners on the floatation device and an attachment point about the opening. The tether can be configured to permit travel of the floatation device within the water storage tank. The apertures, buoyancy of the flotation device, and/or travel of the flotation device can be configured to provide a controlled dissolution rate of the treatment material.

In another embodiment, an apparatus for treating a water source comprises: and a solid phase treatment material for treating the water source, a container configured to hold the solid phase treatment material. The container is removably attached to a flotation device and comprises a bottom surface and sidewall extending from the bottom surface, wherein the bottom surface and/or the sidewall comprise apertures. The apertures, buoyancy of the flotation device, and/or travel of the flotation device are configured to provide a controlled dissolution rate of the treatment material. The water source comprises greater than 100,000 gallons of water.

In one embodiment, the method to maintain residual chlorine levels in water comprises: inserting a solid phase chlorine material for treating a potable water source into a chlorine dispenser comprising a floatation device container configured to hold the solid phase chlorine material (the container has a bottom surface and/or sidewall comprising apertures), disposing the container and floatation device into the water storage tank, wherein the apertures are in fluid communication with the water; and dissolving the solid phase chlorine material at a rate sufficient to maintain a predetermined residual chlorine level in the water for at least about three weeks. Additionally, the dissolution rate of the solid phase chlorine material can be controlled; a plurality of plugs can be added to a selected of the aperture(s), wherein the plugs are configured to prevent fluid communication through the plugged aperture(s); a predetermined amount of weight can be added to the floatation device to change the buoyancy of the floatation device; and/or a depth of the bottom surface of the container can be adjusted relative to the floatation device.

Other elements are also optional with the embodiments. For example, the container can comprise a cover configured to prevent fluid communication through an upper portion of the container opposite the bottom surface, the container can be removably attached to a flotation device, and/or the bottom surface of the container can extends a predetermined depth beneath the floatation device. A plurality of plugs can be removably disposed in a selected one or more of the apertures, wherein the plugs are configured to prevent fluid communication through the selected one or more apertures. The flotation device can comprise a plurality of fasteners attached thereto and configured to removably hold the container. The floatation device can comprise an opening configured to receive the container, wherein the opening has a tapered shape, wherein the container further comprises a corresponding tapered shape such that the container matingly engages the floatation device; optionally, the opening can have protrusion(s) such that a depth that the bottom surface of the container extends beneath the floatation device is adjustable by removal of one or more of the protrusion(s). The solid phase treatment material can comprise tricholoroisocyanuric acid. The tether can be in operative communication with a pulley system, wherein the pulley system is configured to hoist the floatation device out of the potable water up to the opening. The floatation device can comprise a storage compartment configured to hold a plurality of weights and control the buoyancy of the floatation device. Any one or more of these possible elements can be used alone or in combinations with any of the above embodiments as well as other embodiments set forth below.

The treatment material employed in the chlorinator apparatus disclosed herein is safe for use with drinking water (i.e., potable water). In the United States, the Safe Drinking Water Act (SDWA) gives the EPA authority to set the standards for regulating drinking water. In 40 C.F.R. §141, guidelines for the amount of residual disinfectant required for a potable water storage tank are set forth. In an exemplary embodiment, solid tablets of trichloroisocyanuric acid (hereinafter “chlorine”) are used as the treatment material. The chlorine tablets can be placed into a reservoir of the apparatus container. The chlorine tablets are specifically formulated to be suitable for use with drinking water. The apparatus can deliver a disinfectant treatment to a typical potable water storage tank capable of meeting and/or exceeding the treatment guidelines laid out in the regulations above.

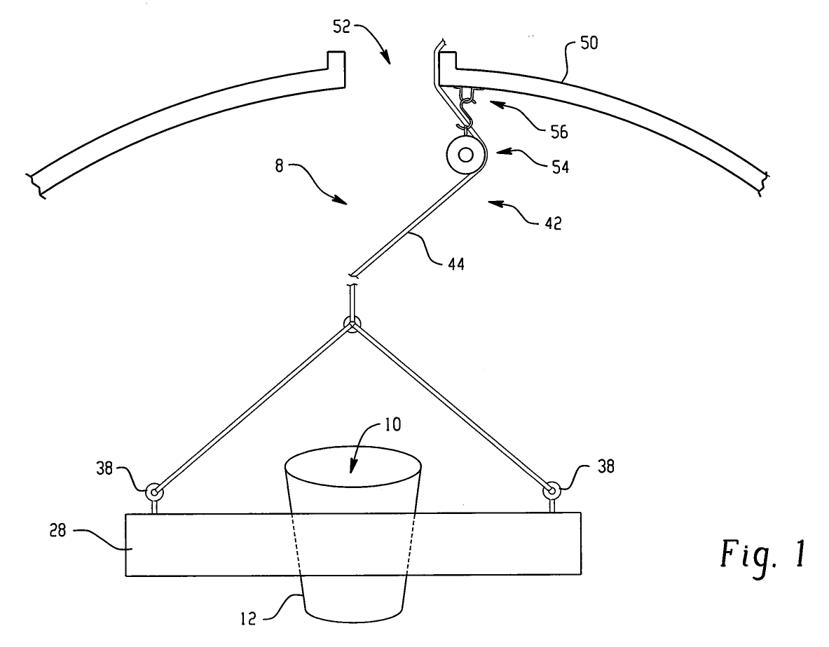

Referring to FIG. 1, an exemplary embodiment of an apparatus 8 is illustrated. The apparatus 8 comprises a container 12 a configured to hold the solid phase treatment material. The container 12 comprises a bottom surface and sidewalls extending from the bottom surface to form the holding portion of the container (i.e., the reservoir 10). The container 12 can be removably attached to a flotation device 28. The apparatus 8 further comprises an opening securement system 42 configured to secure the flotation device 28 to an opening 52 of a storage tank 50. The opening 52 can be the access port of a storage tank, which is typically located on the top of the tank. The apparatus 8 can have any size and shape suitable for use in a predetermined storage tank and capable of floating at varying water levels within the tank. Areas of consideration for the size and shape of the apparatus 8 can be weight, dimensions, and floatability. The apparatus 8 should be light enough for a single person to carry to the top of the storage tank (typically via a ladder); the apparatus should be capable of insertion through existing access hatches in the tank; and the apparatus should be able to float at varying water levels within the tank. In an exemplary embodiment, the dimensions and floatability will be primarily determined by the size, shape, and weight of the flotation device 28, which will be described in detail below.

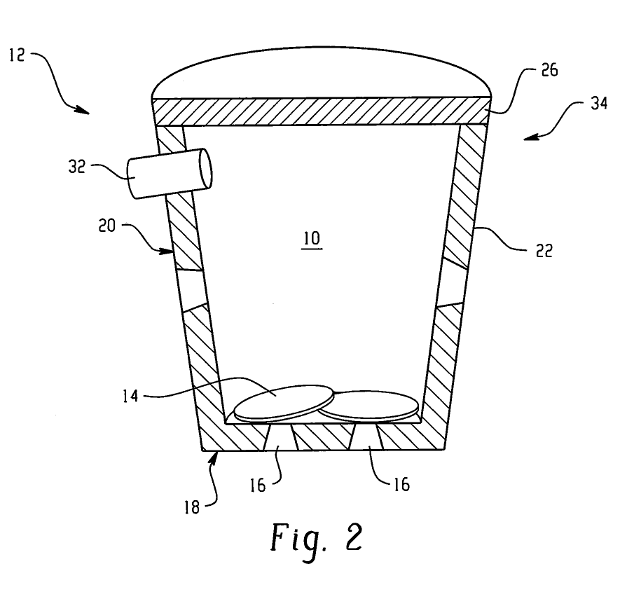

The container 12 can be removed from the inside of the floatation device 28 and is configured to hold and store the disinfectant treatment material. Turning now to FIG. 2, the container 12 comprises a reservoir 10 configured to hold the treatment material 14. The reservoir 10 can have any size and shape suitable for holding the treatment material 14. In a particular embodiment, the reservoir 10 can accommodate at least the amount of treatment material 14 needed to treat the intended water storage tank for a duration of at least about one month. Moreover, the reservoir 10 can be configured to permit expansion of the treatment material 14. As will be described in more detail below, upon contact with water, the treatment material 14 will expand in size. The reservoir 10, therefore, will need sufficient space to accommodate the expansion. The amount of vacant space can be determined by the amount of treatment material 14 needed for a given storage tank system and the predicted volume expansion for a given treatment material. In one example, the reservoir 10 is capable of accommodating about 100 pounds (lbs) of treatment material tablets. This is the amount of material that can be required by a 1,000,000 gallon (3,785 kiloliters (kl)) storage tank. The fact that the reservoir 10 is capable of accommodating such large amounts of treatment material 14 helps eliminate the need for frequent trips to the water storage tank to treat the water. Less trips help reduce costs associated with treating the water. Additional units can be inserted into larger tanks to accommodate larger volumes as needed.

The container 12 can have any shape suitable for disposition in the floatation device 28 while permitting exposure of the treatment material 14 in the reservoir 10 to the potable water. In an exemplary embodiment, the container 12 can have a cylindrical, conical, rectangular, or any similar shape having a bottom surface 18 and sidewalls 22 extending upwardly from the bottom surface 18, to form the reservoir 10. The container 12 can further comprise a cover 26 for enclosing the treatment material 14 in the reservoir 10. The cover 12 can be sized to securely fit the diameter of the upper portion 34 of the container 12 such that the treatment material does not spill out if minor tipping of the floatation device occurs. The container 12 can further comprise a plurality of apertures 16 configured to enable the potable water from the storage tank to be in fluid communication with the treatment material contained in the reservoir 10.

The plurality of apertures 16 can be placed in multiple locations in the container 12, and are sized to accommodate the particular needs of the water tank in which the apparatus 8 is disposed. In one embodiment, the plurality of apertures 16 can be placed on the bottom surface 18 of the reservoir 10. In another embodiment, the plurality of apertures 16 can be disposed throughout the container 12 surface, including the sidewalls 22 as well as the bottom surface 18. Each of the plurality of apertures 16 can have the same diameters, or they can be the same. Likewise, the plurality of apertures 16 can have constant diameters or the diameters can be tapered—either toward the potable water or toward the treatment material. FIG. 2 illustrates a reservoir 10 having a plurality of tapered apertures 16 each having different diameters. The tapered inside diameter of the apertures 16 further enhances the ability to adjust water flow rate through the reservoir 10. In an optional embodiment, the plurality of apertures 16 can further comprise removable plugs 32. The plugs 32 are configured to prevent the water from reaching the treatment material 14 by fitting into the apertures 16 and preventing fluid communication between the water and the reservoir. As discussed, the amount of treatment material 14 require to meet potable water guidelines can depend not only on the particular storage tank, but also on the time of season and the geographic location of the tank. The time of the year and the temperature of the surrounding climate play an impact on both water usage and potential for bacteria growth. The number of apertures 16 in fluid communication with the water (i.e., the unplugged apertures) correlates to the amount of treatment being received by the stored water. The plugs 32 can advantageously provide the ability to customize the apparatus 8 for a particular tank during a particular time of the season.

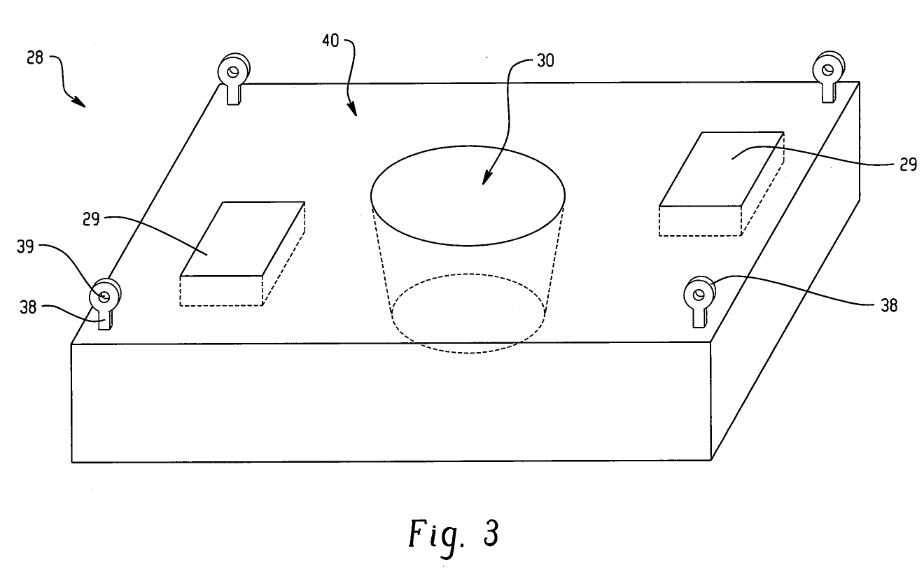

Turning now to FIG. 3, the apparatus 8 is illustrated again with particular detail regarding the floatation device 28. In one embodiment, the floatation device 28 comprises an opening 30 configured to hold the container 12 while permitting at least a portion of the container to be in fluid communication with the potable water. The container 12 and/or the floatation device 28 is/are designed to matingly engage one another in such a way as to position the container 12 relative to the floatation device 28 at a pre-determined height. In the exemplary embodiment illustrated in FIG. 3, the floatation device 28 has a tapered opening 30 such that the diameter of the opening decreases from a top surface of the floatation device to the bottom surface, which is in contact with the water. Likewise, the container 12 will have a similarly shaped taper of its outer surface 20 in order to matingly engage the opening 30 of the floatation device 28. The container 12 can be configured to have a greater upper diameter than that of the opening 30 such that it would be impossible for the container 12 to completely pass through the opening 30. The angle of taper for the container 12 can vary depending on the amount of depth into the water that is desired for the application.

The container 12 and the floatation device 28 can also be in physical communication in a variety of other ways. For example, the device opening can have an inside lip disposed at a pre-determined location (i.e., level) inside the opening 30, wherein the lip is configured to engage a complimentary second lip disposed at a pre-determined level on the container's outer surface 20. As used herein, the term “lip” is generally intended to refer to any protrusion on the floatation device or container that will hold the container within the device and prevent it from slipping through and down to the tank bottom. An exemplary can include, without limitation, a rib, a ledge, a notch, a catch, or other apparatus for engaging the container with the device. In yet another example, the inside surface of the floatation device opening 30 can comprise a threaded fastening means, such as helical screw threads. The container's outer surface 20 can further comprise mating thread patterns for fixedly engaging the device. Other engagement means to position the container 12 at a selected height relative to the floatation device 28 are contemplated herein.

Regardless of the means used to couple the container 12 with the flotation device 28, the height of the container 12 relative to the device 28 can be adjustable in order to control the amount of water that is in fluid communication with the reservoir 10 and, therefore, the treatment material. Raising or lowering the container 12 relative to the device 28 enables such control by exposing, or covering, a certain number of the plurality of apertures 16. The freedom to adjustably control the amount of treatment material exposed to the water is particularly advantageous, because there are many factors that affect how much contact between the treatment material and the water is necessary. For example, in the warmer months, more contact might be necessary, in the cooler months, less. Also, different tank sizes and volumes will require different levels of contact with the treatment material. It will be within the skill of the art of those familiar with potable water treatment conditions for water storage tanks to determine the necessary level of contact (i.e., treatment).

Referring again to FIG. 3, the flotation device 28 is configured to provide the buoyancy to the apparatus 8. The floatation device 28 can have a size and shape suitable to remain floating under the weight of the container and the treatment material therein. Moreover, the floatation device 28 is configured to support the water that enters the reservoir through the plurality of apertures, as well as the weight increase of the treatment material as it absorbs the water. The floatation device 28 is generally larger than the container 12 for buoyancy and balance purposes. In general, and as seen in the embodiment illustrated in FIG. 3, the floatation device has a substantially larger perimeter or circumference than the container. This difference helps to maintain the container in an upright position so that the treatment material 14 does not spill into the tank where the treatment levels can no longer be controlled. In the event of a pipe rupture elsewhere in the system, the water drains from the tank, causing the tethered flotation device to be suspended and to discharge its saturated solution into the water sending a shocking surge of chlorine content to the pipe rupture area of the system, aiding in disinfection of the area.

As stated previously, the floatation device (and the entire apparatus in general) is generally sized to be able to fit through a water storage tank access port. Existing access port openings are generally the size of a manhole, i.e., roughly two feet in diameter, though both round and rectangular access ports are used. In one embodiment, therefore, the device has a rectangular shape. In another embodiment, the device has a round shape.

The floatation device 28 and the container 12 are designed to be of a lightweight material in order to enable carrying of the apparatus 8 to the top of the water tank by one person preferably. Exemplary materials used to make the container 12 and/or the floatation device 28 can be any material that is resistant to chlorine, chemical exposure and corrosion, non-corrosive in water, and approved for contact with drinking water. As mentioned above, various regulations and guidelines exist that mandate the safety of drinking water, for example, many municipalities follow NSF/ANSI Standard 61, which applies to every potable water contact material, product and system, including pipes, mechanical devices, plumbing products, and process media. Those same guidelines will be applicable to the apparatus 8 as disclosed herein. In one embodiment, therefore, container 12, floatation device 28, and other apparatus components in possible contact with the water can comprise polypropylene, high density polyethylene, other materials that are acceptable for direct contact with potable water, as well as a combination of the foregoing materials.

As discussed above, it is desirable to be able to adjust the amount of water that is in fluid communication with the treatment material 14. Another method of adjusting the treatment level to the water aside from controlling container submersion depth is by adjusting the submersion level of the entire floatation device in the water. In such an embodiment, the device 28 can further comprise one or more additional openings, storage compartments 29, or the like, where sink weights or other material can be added or removed to control the submersion depth of the device, and therefore, the amount of the reservoir in the water. In one embodiment, the storage compartments 29 can be water tight and configured to hold additional treatment material that can be added to the container when necessary to refresh the apparatus. This can further reduce the amount of necessary trips up the storage tank ladder carrying chlorination apparatuses or treatment materials.

Turning back now to FIG. 1, the apparatus 8 further comprises the opening securement system 42. The opening securement system 42 as described herein enables easy retrieval of the floatation device and container after it has been paced down into the water storage tank, if for instance, the treatment material needs to be refilled/replaced. Without such a system, retrieving the apparatus 8 could be extremely difficult, even hazardous. For example, there is no way to predict where the apparatus 8 will be located within the tank. At any particular moment in time, the apparatus 8 could a few feet to more than 50 feet below the access port surface. The opening securement system 42 eliminates this issue by making the apparatus 8 easily retrievable regardless of its location within the tank. The opening securement system 42 can include any suitable means for permitting horizontal and vertical travel of the floatation device while maintaining a fixed attachment point at the access port. An exemplary opening securement system further comprises a means of easily hoisting the apparatus 8 up from the water level to the port, preferably to be done by a single operator.

In one embodiment, a plurality of fasteners 38 extend from the floatation device 28. Exemplary fasteners can include, without limitation, hooks, such as S-hooks, bolts, such as eye-bolts or U-bolts, pins, anchors, and the like. In one embodiment, the fasteners 38 extend from the upper surface 40 of the floatation device 28 and are located around the perimeter of the device so as not to tip the apparatus as it is being retrieved. To that point, in one embodiment, the fasteners 38 are disposed equidistantly about the perimeter of the device. For example, in the case of a rectangular device 28, the fasteners 38 can be fixedly attached to the device at least on the top surface of the four corners of the device. The fasteners 38 can preferably comprise an opening 39 for threading a tether 44 (e.g., a rope, cable, cord, or the like). One end of the tether 44 can be secured to each fastener 38 and brought together at a central position above the device 28 such that the device would remain level as the apparatus is pulled from the water. Each of the tether attachment points can be secured together in the central position by a knot or clamping apparatus to provide one uniform tether for which to attach to the access port. In an exemplary embodiment, the tether 44 is long enough to enable the floatation device 28 to freely float about and traverse the varying water levels in the storage tank.

The opening securement system 42 is configured to anchor the apparatus 8 to the access port 52 of the storage tank 50. For example, in one embodiment, the tether 44 is attached to a pulley system 54. The pulley system 54 can be secured to an attachment point 56, such as a hook, on the access port 52. In one embodiment, the attachment point 56 comprises an “S” type hook, wherein one end is fixedly or removably engaged to the access port 52, and the pulley system 54 and the tether 44 hang from the other end. In another embodiment, the attachment point 56 can comprises a clamp, which is able to clamp together the tether 44 to the access port 52. When it is time to retrieve the apparatus 8, the operator is able to easily pull, for example, the tether 44 and bring the apparatus up out of the tank with relative ease via use of the pulley system 54. The opening securement system 42 may be left inside the water storage tank for later use with a replacement device and container if necessary.

The treatment material 14, i.e., chlorine, is dissolved into the water a continuous rate to maintain the residual chlorine content in the water storage tanks. The chlorine treats the potable water as the water flows through the plurality of apertures in the container, contacting and dissolving the treatment material in the reservoir 10, and releasing the treatment material 14 into the water. The dissolution rate is determined in part by the amount of water that is allowed to be in fluid communication with the reservoir 10. This can be controlled, as discussed above, by a variety or combination of methods. To reiterate, the height of the container 12 relative to the floatation device 28 can be raised or lowered to control how many of the apertures 16 are exposed to the water; or removable plugs 32 can be added or removed to the apertures to again control exposure; or the submersion level of the floatation device 28 can be controlled through the addition or subtraction of weight to control the depth of the reservoir in the water. In yet another method, the diameter and/or geometry of the apertures 16 can be configured to control ingress/egress of water through the reservoir 10. All of these control methods can be used alone or in combination, depending upon the particular needs.

In operation, the apparatus can be used to maintain residual chlorine levels in potable water located in a water storage tank. In one embodiment, such a method can include inserting a solid phase treatment material for treating a potable water source into a container configured to hold the solid phase treatment material, wherein the container comprises a bottom surface and sidewalls extending from the bottom surface, wherein a selected one or both of the bottom surface and sidewalls comprise apertures. The container can then be placed in the flotation device, wherein the flotation device comprises a plurality of fasteners attached thereto and is configured to removably hold the container. Together the container and flotation device can be disposed into the tank, either by lowering with the securement system (e.g. with the pulley) or by merely placing the apparatus into the water when the level is high enough in the tank. Now that the apertures are in fluid communication with the potable water, the treatment material will begin to dissolve. As stated above, the dissolution rate can be controlled to maintain a rate sufficient to keep the potable water at predetermined residual chlorine level for greater than or equal to two weeks, or, specifically, greater than or equal to three weeks, or, more specifically, greater than or equal to about 4 weeks; even when the water is not temperature controlled and the ambient temperature around water exceeds 80° F. (27° C.).

As mentioned earlier, there apparatus disclosed herein can treat water without the need for a large treatment system infrastructure, or in a situation where the water storage tank is not connected to a water supply network, for example, an individual open water storage tank that is used in a remote or temporary location. The apparatus and method disclosed herein is particularly useful in maintaining a residual chlorine level for a period of at least about one month without need of servicing. Moreover, the apparatus does not require power, so treatment is possible regardless of the availability of any power, whether electrical, battery, solar, or the like. The apparatus is particularly suitable for large municipal size water storage tanks that hold many gallons of water and have access ports located high off the ground; e.g., storage tanks having a capacity of greater than or equal to 100,000 gallons, or, specifically, greater than 300,000 gallons, or, more specifically, greater than 500,000 gallons, or, yet more specifically, greater than 1,000,000 gallons, and even greater than or equal to 5,000,000 gallons; e.g., 500,000 gallons to 10,000,000 gallons or so. The apparatus reduces the number of trips to the top and the total weight carried during those trips when compared to treatment methods often used for such systems.

An additional advantage of the present system and method is the reduced costs. The cost of a tank-sited chlorination system specifically designed to maintain residual chlorine levels in such a storage tank will run currently in the range of $650,000 and up, depending on size, location and capability. Compounding the costs are the extra security required to maintain the security of the liquid chlorine storage tanks, especially in remote areas where clandestine activities may be easier to execute. The present system and method can reduce the costs by 50% and even more. Additionally, since the system and method are not dependent upon machinery or moving parts, the changes of system failure or problems are drastically reduced if not eliminated. For example, in the event of a power failure, the present chlorination apparatus will continue to function as designed. However, mechanical chlorination systems (e.g., that employ liquid chlorine), while temporary power may be available to the pumps for continued pressurization, ensuring back-up power to every tank and its sophisticated chlorination system would be prohibitively expensive. Thus, keeping things simple is attractive.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The terms “front”, “back”, “bottom”, and/or “top” are used herein, unless otherwise noted, merely for convenience of description, and are not limited to any one position or spatial orientation. The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the claims not be limited to the particular embodiment(s) disclosed as the best mode contemplated for carrying out this invention, but that the invention will include all embodiments falling within the scope of the appended claims.

What is claimed is:

1. An apparatus for treating a potable water source in a water storage tank having at least one opening for access to the potable water, the apparatus comprising:
a solid phase treatment material for treating the potable water source;
a solid phase treatment material dispenser comprising a floatation device and a container configured to hold the solid phase treatment material, wherein the container comprises a bottom surface and sidewall extending from the bottom surface, wherein the bottom surface and/or the sidewall comprise apertures; and
an opening securement system comprising a tether in operative communication with the plurality of fasteners and an attachment point about the opening, wherein the tether is configured to permit travel of the floatation device within the water storage tank, wherein the apertures, buoyancy of the flotation device, and/or travel of the flotation device are configured to provide a controlled dissolution rate of the treatment material.

2. The apparatus of claim 1, wherein the container further comprises a cover configured to prevent fluid communication through an upper portion of the container opposite the bottom surface.

3. The apparatus of claim 1, further comprising a plurality of plugs removably disposed in a selected one or more of the apertures, wherein the plugs are configured to prevent fluid communication through the selected one or more apertures.

4. The apparatus of claim 1, wherein the container is removably attached to a flotation device.

5. The apparatus of claim 4, wherein the flotation device comprises a plurality of fasteners attached thereto and configured to removably hold the container.

6. The apparatus of claim 5, wherein the floatation device further comprises an opening configured to receive the container, wherein the opening has a tapered shape; and wherein the container further comprises a corresponding tapered shape such that the container matingly engages the floatation device.

7. The apparatus of claim 5, wherein the floatation device further comprises an opening configured to receive the container, wherein the opening has protrusions and a tapered shape; wherein the container further comprises a corresponding tapered shape such that the container matingly engages the floatation device; wherein a depth that the bottom surface of the container extends beneath the floatation device is adjustable by removal of one or more of the protrusions.

8. The apparatus of claim 1, wherein the solid phase treatment material is tricholoroisocyanuric acid.

9. The apparatus of claim 1, wherein the tether is in operative communication with a pulley system, wherein the pulley system is configured to hoist the floatation device out of the potable water up to the opening.

10. The apparatus of claim 1, wherein the floatation device further comprises a storage compartment configured to hold a plurality of weights and control the buoyancy of the floatation device.

11. The apparatus of claim 1, wherein the bottom surface of the container extends a predetermined depth beneath the floatation device.

12. A method to maintain residual chlorine levels in water located in a water storage tank, the method comprising:
inserting a solid phase chlorine material for treating a potable water source into chlorine dispenser comprising a floatation device and a container configured to hold the solid phase chlorine material, wherein the container comprises a bottom surface and a sidewall extending from the bottom surface, wherein the bottom surface and/or sidewall comprise apertures;
disposing the chlorine dispenser into the water storage tank, wherein the apertures are in fluid communication with the water; and
dissolving the solid phase chlorine material at a rate sufficient to maintain a predetermined residual chlorine level in the water for at least about three weeks.

13. The method of claim 12, further comprising controlling the dissolution rate of the solid phase treatment material.

14. The method of claim 13, further comprising adding a plurality of plugs to a selected one or more of the apertures, wherein the plugs are configured to prevent fluid communication through the selected one or more apertures.

15. The method of claim 13, further comprising adding a predetermined amount of weight to the floatation device.

16. The method of claim 13, further comprising adjusting a depth of the bottom surface of the container relative to the floatation device.

17. The method of claim 13, wherein the solid phase treatment material is a tricholoroisocyanuric acid.

18. The method of claim 13, further comprising refilling the container with the treatment material, wherein refilling comprises:
hoisting the floatation device from the potable water to an access opening in the water storage tank with a tether in operative communication with a pulley system, wherein the tether is in operative communication with the plurality of fasteners and an attachment point about the access opening, and wherein the pulley system is configured to hoist the floatation device out of the potable;
removing the container from the floatation device without removing the floatation device from the water storage tank;
disposing additional treatment material into the container; and
returning the container to the floatation device.

19. The method of claim 12, further comprising tethering the floatation device about an opening for access in the water storage tank; and

20. The method of claim 19, further comprising adjusting the dissolution rate of the solid phase treatment material.

21. An apparatus for treating a water source, comprising:
a solid phase treatment material for treating the water source; and
a dispenser for the solid phase treatment material comprising a floatation device and a container configured to hold the solid phase treatment material, wherein the container comprises a bottom surface and sidewall extending from the bottom surface, wherein the bottom surface and/or the sidewall comprise apertures;
wherein the apertures, buoyancy of the flotation device, and/or travel of the flotation device are configured to provide a controlled dissolution rate of the treatment material;
wherein the water source comprises greater than 100,000 gallons of water.

22. The apparatus of claim 21, wherein the storage capacity is greater than 500,000 gallons.

23. The apparatus of claim 22, wherein the storage capacity is greater than 1,000,000 gallons.

24. The apparatus of claim 22, wherein the floatation device further comprises an opening configured to receive the container, wherein the opening has protrusions and a tapered shape; wherein the container further comprises a corresponding tapered shape such that the container matingly engages the floatation device; wherein a depth that the bottom surface of the container extends beneath the floatation device is adjustable by removal of one or more of the protrusions.
